(19) United States
(12) Patent Application Publication
(10) Pub. No.: US 2011/0275420 A1
(43) Pub. Date: Nov. 10, 2011

(54) 4-in-1 Box Integrating Paperweight, Name Card, Mobile Phone and Charger

(76) Inventor: John Tsao, Taipei (TW)

(21) Appl. No.: 12/774,359

(22) Filed: May 5, 2010

(51) Int. Cl. H04B 1/38

(52) U.S. Cl. 455/572; 455/575.1

(57) ABSTRACT

A 4-in-1 box integrating paperweight, name card, mobile phone and charger, which is mainly provided with a box body; the box body is provided with a replaceable echelonment baffle that is used to separate it into a semi-open first/second holding space and a confined space; the first and second holding spaces are used to accommodate personal belongings, such as: notepaper, name card and mobile phone, individually or simultaneously; the open end of the first holding space is provided with a curved opening for easier extraction; the confined space is fitted with an IC circuit board and connected with AC power line; a charger adapter is placed into the second holding space, and can be replaced for real-time charging different mobile phones.

### BACKGROUND OF INVENTION

1. Field of the Invention

The present invention relates generally to a box for collecting personal belongings and for decorative arrangement, and more particularly to an innovative one which is designed uniquely to integrate paperweight, name card, mobile phone and charger.

2. Description of Related Art

Many people intend to place or arrange personal belongings on the table or desk, such as: notepapers, name cards, mobile phones or paperweights, via the help of card cases and phone holders, etc; however, a bigger space is required for arrangement of such articles, making it inconvenient to fetch and use them in an orderly manner.

Firstly, the conventional card cases are mainly made of plastics and composed of upper and lower casings for easier access; yet, these plastic card cases cannot be flexibly utilized due to inconvenience and lack of environmental friendliness.

Secondly, the phone holders are mainly designed into open, depressed ornament, so that the users always place the mobile phones onto the depressed part; in such case, some lightweight phone holders are vulnerable to turnover caused by the vibration of the mobile phone when a call is connected.

Thirdly, the paperweights are short of functions apart from the changes of shape or pattern, thus reducing greatly the availability when environmental protection and lower paper consumption are required.

Fourthly, the mobile phone chargers are only provided for specific types of mobile phones, so these mobile phones in an idle state are not placed onto the chargers, making it difficult to realize space-saving or decorative or aesthetically-pleasing effect.

Thus, to overcome said problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### CONTENT OF INVENTION

The primary objective of the present invention is to provide a 4-in-1 box integrating paperweight, name card, mobile phone and charger, helping to realize multi-purpose performance and value.

The second objective of the present invention is to provide a 4-in-1 box integrating paperweight, name card, mobile phone and charger, helping to realize space-saving effect for the paperweight with individual style and characteristics as well as decorative and aesthetically-pleasing effect.

The third objective of the present invention is to provide a 4-in-1 box integrating paperweight, name card, mobile phone and charger, helping to arrange the personal belongings, such as: name card and mobile phone, and also charge the mobile phone in a real-time manner.

The fourth objective of the present invention is to provide a 4-in-1 box integrating paperweight, name card, mobile phone and charger, helping to realize advertisement effect through specific or common patterns, or personal information or serial number, or even company profile on the box surface for business promotion.

For said purposes, the 4-in-1 box of the present invention is mainly provided with a box body, into which a replaceable echelonment baffle is used to separate it into a semi-open first/second holding space and a confined space; the first and second holding spaces are used to accommodate personal belongings, such as: notepaper, name card and mobile phone, individually or simultaneously; moreover, the open end of the first holding space is provided with a curved opening for easier extraction; the confined space is fitted with an IC circuit board and connected with AC power line; a charger adapter is placed into the second holding space, and can be replaced for real-time charging different mobile phones. To highlight the personal belongings, various patterns or individual, company advertisement information are printed on the flange of the box body for decoration and advertisement purposes; in addition, the box body can be made of many materials including: paper, porcelain, timber, glass, acryl, crystal, colored glaze, clothes, aluminum alloy and leather, thus enabling users to arrange the personal belongings and also make it available for the paperweight and ornament with diversified functions.

The features and the advantages of the present invention will be more readily understood upon a thoughtful deliberation of the following preferred embodiment with reference to the accompanying drawings.

### SUMMARY OF THE INVENTION

FIGS. 1-3 depict the external and application views of a preferred embodiment of the 4-in-1 box integrating paperweight, name card, mobile phone and charger; as disclosed in FIG. 1, the box body 1 is prefabricated into a hollow rectangular shape, onto which a slot 11 with curved opening 10 is set; and the box body 1 is fitted with a replaceable echelonment baffle 12, which is used to separate it into a semi-open first/second holding space 13, 14 and a confined space 15; of which the first holding space 13 is used to place the name card 2 or notepaper, and the curved opening 10 is introduced for easier extraction, as shown in FIG. 2; the second holding space 14 is used to place temporarily the mobile phone 3 for random access, as shown in FIG. 3; the confined space 15 is fitted with an IC circuit board 151 and connected with AC power line 152; a charger adapter 121 is placed into the second holding space 14 , and can be replaced for real-time charging the mobile phone 3, as shown in FIGS. 4-5; in practice, an exposed charger adapter 121 is placed at proper location of the baffle 12, and a concealed lead 122 is used for electrical connection with the IC circuit board 151, such that the mobile phone 3 can be electrically connected and charged when it is put aside. Yet, there are a variety of charger adapters 121 for different types of mobile phones 3; furthermore, the charger adapters 121 can be positioned flexibly depending on the mobile phone 3 (e.g. in FIG. 4, shift from the center to left or right, or the wall).

In addition to horizontal arrangement, the box body 1 can also be arranged vertically, and fastened onto any wall by means of hanging or adhesion for diversified and convenient arrangement.

Said box body 1 and baffle 12 are made of such materials as paper, porcelain, timber, glass, acryl, crystal, colored glaze, clothes, aluminum alloy and leather, of which the soft or plastic materials such as: paper, clothes and leather, can be unfolded and then fabricated into the box body; and the solid materials such as: porcelain, timber, glass, acryl, crystal, colored glaze and aluminum alloy, can be prefabricated into the box body; so the box body can not only be used for arrangement of personal belongings, but also for charging the mobile phones and incorporating the paperweight and ornament to provide fashionable visual effect.

Moreover, if the box body 1 is made of unicolored or colorless materials, advertisement information 16 such as: special patterns, company identification symbol or graph, or text message, or user name, telephone, fax, address and serial number, can be printed properly on the circumference of the box body 1, along with the name cards 2, thus forming a unique and multi-functional card case to meet the individual requirements.

Moreover, as the box body 1 of the present invention can be used for stable arrangement with its bigger footprint, it can also be combined with different types of materials to form paperweight and ornament in the working environment with better decorative and visual effect. Also, advertisement information 16 of different materials can be presented for business exchange in various fields.

As a whole, the “4 in 1 box integrating paperweight, name card, mobile phone and charger” has been fully understood with respect to its expected efficacy and purposes as a novel utility model, so the following claims are made in full compliance with the requirements of new patent application.

Although the invention has been explained in relation to its preferred embodiment, it is to be understood that many other possible modifications and variations can be made without departing from the spirit and scope of the invention as hereinafter claimed.

### BRIEF DESCRIPTION OF THE DRAWINGS

FIG 1: an unfolded view of a preferred embodiment of the present invention.

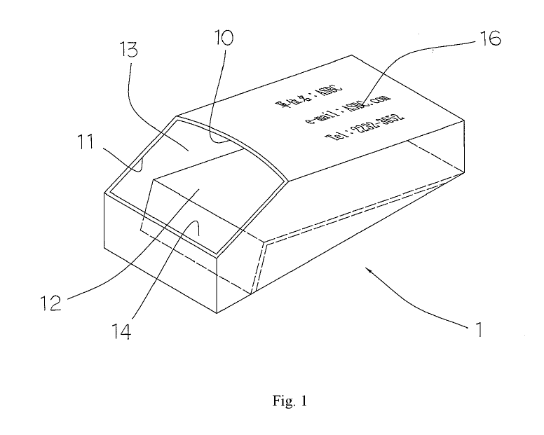

FIG. 2: an external view of a preferred embodiment of the present invention.

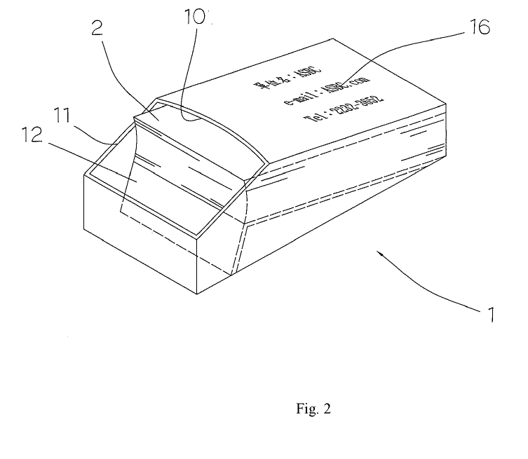

FIG. 3: an application view of a preferred embodiment of the present invention.

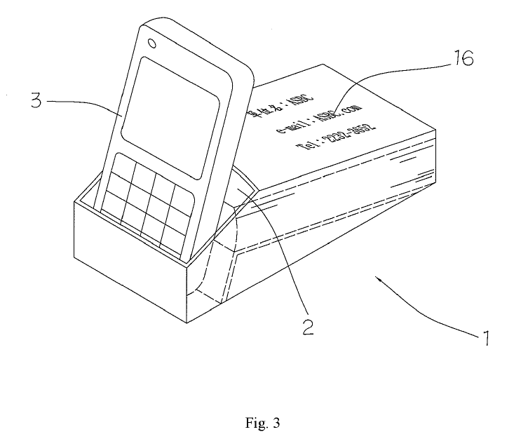

FIG. 4: another application view of a preferred embodiment of the present invention.

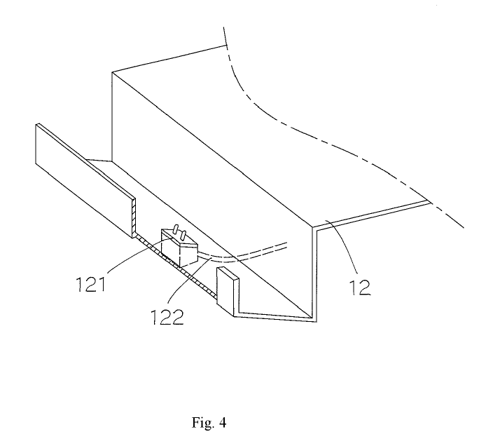

FIG. 5: a structural view of another preferred embodiment of the present invention.

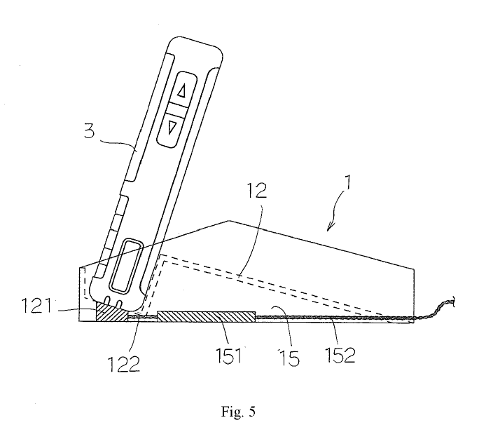

1. A 4-in-1 box integrating paperweight, name card, mobile phone and charger, which is mainly provided with a hollow box body; the box body is provided with a replaceable echelonment baffle that is used to separate it into a semi-open first/second holding space and a confined space; the first and second holding spaces are used to accommodate personal belongings; the confined space is fitted with an IC circuit board and connected with AC power line; a charger adapter is placed into the second holding space; thus, the present invention can not only be used for arrangement of personal belongings, but also for incorporating the paperweight and ornament to provide diversified efficacies.

2. The structure defined in claim 1, wherein the baffle is of echelonment profile.

3. The structure defined in claim 1, wherein the first holding space is provided with a curved opening.

4. The structure defined in claim 1, wherein the charger adapter can be replaced randomly depending on the mobile phone.

5. The structure defined in claim 1, wherein the box body and baffle are individually made of paper, porcelain, timber, glass, acryl, crystal, colored glaze, clothes, aluminum alloy and leather.

6. The structure defined in claim 5, wherein the boxy body made of soft or plastic materials, such as: clothes and leather, can be unfolded and then fabricated.

7. The structure defined in claim 5, wherein the box body made of solid materials, such as: porcelain, timber, glass, acryl, crystal, colored glaze and aluminum alloy, can be prefabricated.

8. The structure defined in claim 1, wherein advertisement information, such as: any designated or special patterns and text message, can be printed properly on the circumference of the box body.

9. The structure defined in claim 1, wherein the back of the box body can be fastened onto any wall by means of hanging or adhesion.
